(19) United States
(12) Patent Application Publication
(10) Pub. No.: US 2005/0256807 A1
(43) Pub. Date: Nov. 17, 2005

(54) Apparatus, system, and method for ultraviolet authentication of a scanned document

(76) Inventor: James Gabriel Brewington, Raleigh, NC (US)

Correspondence Address: KUNZLER & ASSOCIATES, 8 EAST BROADWAY, SUITE 600, SALT LAKE CITY, UT, 84111, US

(21) Appl. No.: 10/846,715

(22) Filed: May 14, 2004

(51) Int. Cl. G06F 7/04; G06F 17/60; G08B 29/00; G06K 7/10; G06K 9/64; G06K 9/78; H04N 1/04; G07D 7/00; G01J 1/42

(52) U.S. Cl. 705/67; 356/71; 250/372; 235/468; 382/217; 340/5.86; 358/474

(57) ABSTRACT

An apparatus, system, and method are disclosed for authenticating a scanned document. Namely, the apparatus includes an ultraviolet (UV) illumination source, a photosensor array, an image processing module, and an image verification module. The UV illumination source illuminates a document having a UV image printed thereon. The photosensor array senses the UV image while the document and UV image are illuminated by the UV illumination source. The image processing module digitally processes the sensed UV image. The image verification module compares the processed UV image with a corresponding benchmark image to determine if the scanned document is authentic.

### BACKGROUND OF THE INVENTION

1. Field of the Invention

This invention relates to digital scanners and more particularly relates to authenticating a scanned document by scanning and authenticating an ultraviolet (UV) image.

2. Description of the Related Art

Electronic scanning devices have been incorporated into the business and personal computing world for some time now. For example, fax machines scan images prior to transmitting them over analog telephone lines, document scanners in the form of copiers and stand-alone scanners allow entire documents to be scanned and digitally saved, and retail point-of-sale (POS) printers incorporate scanners to scan checks to verify funds.

With the rise in use of digital computing equipment and especially scanning equipment, however, it is less and less difficult to forge or otherwise imitate important documents of all kinds, including checks, currency, official documents, and so forth. In an attempt to preclude such imitations, document designers and producers may incorporate several “security” features into their documents. For example, some documents have visible watermarks; some documents have security codes; some documents incorporate micro-printing; some documents use only specialty printing media (i.e., the paper used to mint U.S. currency); some documents have unique serial numbers; and, some documents incorporate digitally-readable pattern codes, such as bar codes or data matrices. While many of these security features may deter forgery and unauthorized duplication, they do not fully prevent someone from copying or otherwise producing illegitimate, even illegal, documents.

Another security feature that may be employed to identify official documents is the use of a phosphorous ink that is only visible under a special ultraviolet (UV) light source. This is similar to the technology used by some amusement parks to mark patrons with a UV image (by stamping the back of the patron's hand) and verifying the mark upon reentry to the park, for example, by using a UV lamp. When the patron's hand is placed under the UV lamp, the previously invisible stamp becomes apparent and may be verified by a park employee. Although invisible without the use of a UV light source, this security feature is still subject to copying when the technology is known and a single mark is used to identify a plurality of documents.

In addition to the failure of these security features to fully deter unauthorized imitation of important documents, the effectiveness of these security features is limited by the ineffective procedures for manually verifying and authenticating each document. Very few, if any automated procedures are in place to authenticate documents, especially in retail businesses and other locations where such validation of conventional security features may be cost-prohibitive.

From the foregoing discussion, it should be apparent that a need exists for an apparatus, system, and method that more precisely and automatically authenticate a scanned document. Beneficially, such an apparatus, system, and method would employ one or more security features that are not readily apparent to potential imitators, as well as facilitate technology that is more accurate and reliable than conventional, error-prone manual verification.

### SUMMARY OF THE INVENTION

The present invention has been developed in response to the present state of the art, and in particular, in response to the problems and needs in the art that have not yet been fully solved by currently available document scanning and authentication systems. Accordingly, the present invention has been developed to provide an apparatus, system, and method for ultraviolet authentication of a scanned document that overcome many or all of the above-discussed shortcomings in the art.

The apparatus to authenticate a scanned document is provided with a logic unit containing a plurality of modules configured to functionally execute the necessary steps of ultraviolet authentication of a scanned document. These modules in the described embodiments include an array control module, a conventional illumination control module, a UV illumination control module, a document feed module, an image processing module, and an image verification module.

The apparatus, in one embodiment, is configured to scan a document for a UV image that is not visible either to the naked eye or using a conventional scanning technology. In one embodiment, the apparatus includes a UV illumination source to illuminate a document and a photosensor array to sense or detect a UV image printed on the document. The UV illumination module controls the UV illumination source and the array control module controls the operation of the photosensor array. The document feed module controls the rate at which a document is passed by the UV illumination source and photosensor array.

The image processing module is configured to use the sensed UV image to create a processed UV image that is capable of being digitally stored and otherwise manipulated. In one embodiment, the image verification module used the processed UV image to compare with a benchmark image corresponding to the scanned document to determine if the scanned document is authentic. The processed UV image and the benchmark image may be representative of an alphanumeric code, a pattern code, an image, a symbol, or a combination of various marks. In one embodiment, the printed UV image is applied to the scanned document (prior to scanning, of course) using a phosphorous ink or other medium that is visible under a UV light source.

The apparatus is further configured, in one embodiment, to also scan the document for conventional images, including visible text, graphics, and other markings. Some of the convention images may include one or more conventional security features described above.

A system of the present invention is also presented to authenticate a scanned document using UV imaging. In one embodiment, the system comprises a contact image scanner in which the scanned document is effectively placed in contact with the UV illumination source and the photosensor array (perhaps with an interposed glass plate, for example).

In a further embodiment, the system may comprise a point-of-sale (POS) printer that is configured to scan, for example, a personal or business check. In addition to a contact image scanner or other UV scanner, the POS printer may include a printer that is configured to print information on the check before, after, or during scanning of the check for authentication purposes.

Whether incorporated in a contact image scanner, a POS printer, or another comparable scanning system, the UV image scanner, as well as the conventional image scanner and/or printer, may operate using either single-pass technology or multiple-pass car technology.

A method of the present invention is also presented for authenticating a scanned document. The method in the disclosed embodiments substantially includes the steps necessary to carry out the functions presented above with respect to the operation of the described apparatus and system. In one embodiment, the method includes scanning the document using a UV illumination source and a UV or dual-mode photosensor array, digitally processing the detected image, and comparing the processed UV image with a corresponding benchmark image. In one embodiment, the corresponding benchmark image is determined by the scanned document, such as by a document identifier, as described herein. The method also may include scanning and processing a conventional image, controlling the UV illumination source and photosensor array, accessing the benchmark image from a remote server or database, and so forth.

Advantageously, certain embodiments of the present invention facilitate enhanced security authentication of a variety of scanned documents. In particular, the present invention, in various embodiments, provides for UV scanning of a document and image verification of the processed UV image, according to a predefined benchmark image that is associated with the scanned document. Additionally, the possibility and likelihood of operator error is greatly reduced due to the automated nature of the UV technology described.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic diagram illustrating one embodiment of a point-of-sale apparatus in accordance with the present invention;

FIG. 2 is a schematic diagram illustrating a sectional view of one embodiment of a contact image sensor system in accordance with the present invention;

FIG. 3 is a schematic diagram illustrating a plan view of one embodiment of a contact image sensor system in accordance with the present invention.

FIG. 4 is a schematic diagram illustrating a plan view of one embodiment of a contact image sensor system having UV illumination sources in accordance with the present invention.

FIG. 5 is a schematic block diagram illustrating one embodiment of an authentication system in accordance with the present invention;

FIG. 6 is a schematic block diagram illustrating one embodiment of a dual-mode image scanner in accordance with the present invention;

FIG. 7 is a schematic diagram illustrating one embodiment of a document having a conventional image in accordance with the present invention;

FIG. 8 is a schematic diagram illustrating one embodiment of a processed UV image in accordance with the present invention; and

FIG. 9 is a schematic flow chart diagram illustrating one embodiment of an authentication method in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

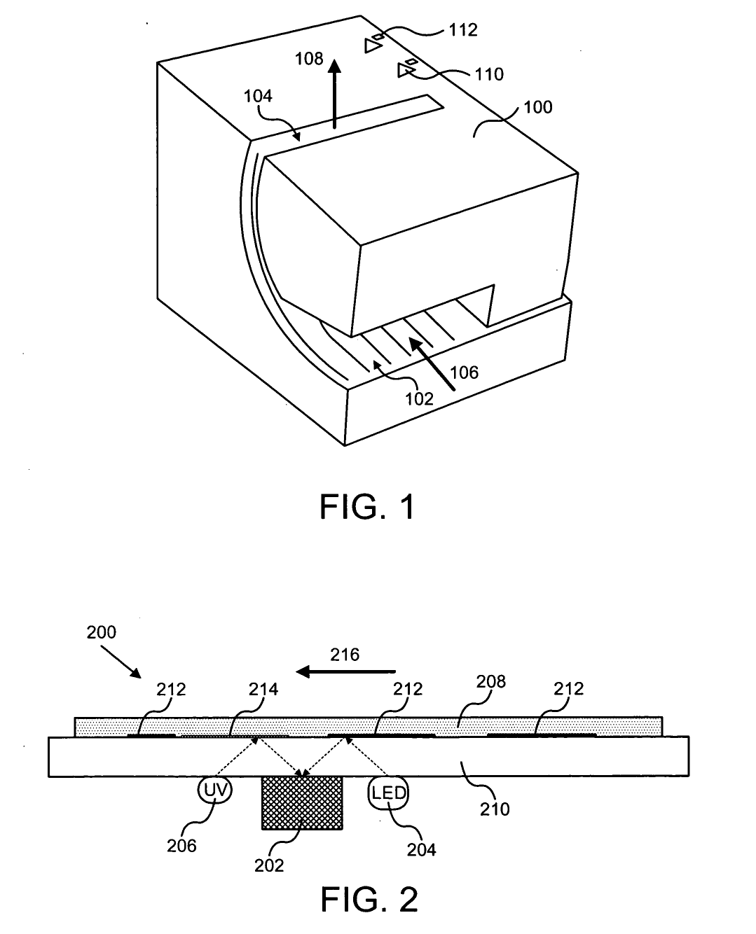

FIG. 1 depicts one embodiment of a point-of-sale (POS) apparatus 100 in which certain embodiments of the present invention may be incorporated. The depicted POS apparatus 100 may be located at a retail checkout counter and connected to a cash register and used, for example, to print receipts and scan customer checks. Although the present description focuses on the point-of-sale apparatus 100, other embodiments of the present invention may be employed in various other apparatuses, including ticket scanners, flatbed scanners, and any other type of device that employs digital scanning technology to read identifiable documents and other media.

The illustrated POS apparatus 100 specifically includes a scanning portal having a first aperture and a second aperture 104. These apertures are configured to facilitate insertion and ejection of a document, such as a check, from the POS apparatus 100. A scanner (not shown), such as a contact image scanner (CIS), may be located internally to the housing of the POS apparatus 100 and configured to scan checks or other documents as the documents are passed from one aperture 102 to the other 104. For instance, when a document is inserted in the first aperture 102 in the indicated direction 106, a document feed mechanism (not shown), such as mechanical rollers, may feed the document through the POS apparatus 100. As the document moves between apertures 102, 104, it may be scanned by the contact image scanner before being ejected through the second aperture 104 in the indicated direction 108.

In further embodiments, the POS apparatus 100 may facilitate multiple passes of the document by the scanner by reversing the feed direction without fully ejecting the document. In other words, after scanning the document a first time in the indicated directions 106, 108, the POS apparatus 100 may reverse the document feed mechanism and pass the document by the scanner again, although in a direction opposite the indicated direction 106, 108. In this way, the POS apparatus 100 may facilitate multiple passes of the document by the scanner and allow the scanner to scan the document more than once, if necessary. Additionally, the POS apparatus 100 may employ one or more passes of the document in order to print text or other images on the document.

The illustrated POS apparatus 100 also may include user control 110 and indicators 112 to receive user inputs and communicate status information to the user, respectively. One example of a POS apparatus 100 that may be employed within the present description is the SureMark Dual-Station printer available from IBM® (www.ibm.com). Other possible features and embodiments of the POS apparatus 100 are foreseeable within the context of the described POS apparatus 100 and are understood to be within the many embodiments of scope of the many embodiments of the present invention.

FIG. 2 depicts a sectional view of one embodiment of a contact image scanner 200 that may be incorporated into the POS apparatus 100 of FIG. 1. The illustrated contact image scanner 200 includes a photosensor array 202, a conventional illumination source 204, and an ultraviolet (UV) illumination source 206. These devices may be proximately located next to a glass plate 210, in one embodiment, on which or by which a document 208 may be passed. As the document passes, the conventional images 212 and V images 214 printed thereon may be scanned. The document 208 may pass by the photosensor array 202 and illumination sources 204, 206 in the indicated direction 216 (or in the reverse direction).

In order to scan the conventional images 212 printed on the document 208, the conventional illumination source 204 illuminates at least a portion of the document 208 near the photosensor array 202. Light that is reflected back from the document 208 and toward the photosensor array 202 (as depicted by the dashed arrows) is detected at the photosensor array 202 and may be digitally processed to detect the conventional images 212. The term “conventional illumination source” generally refers to any conventional source of illumination that may be employed to effectively illuminate the document 208 in order to be scanned. Although light emitting diodes (LEDs) may be employed and are depicted and described herein, many types of illuminating devices may be considered a “conventional illumination source.” LEDs, therefore, are not the only type of conventional illumination source that may be employed within certain embodiments of the present invention.

In a similar manner, UV light may be transmitted by the UV illumination source 206, reflected off the surface of the document 208, and detected at the photosensor array 208. In this way, the UV images 214 printed on the document 208 also may be sensed and processed by the scanner 200. In one embodiment, the UV image 214 may comprise a phosphorous ink that is sensitive to and visible under UV light. However, other types of UV inks may be employed, also. Furthermore, the UV illumination source 206 may be any illumination source capable of effectively illuminating a UV image 212 so that it may be detected by the photosensor array 202. In one embodiment, the UV illumination source comprises a UV LED, such as the UV LED available from Marubeni (www.marubeni.com).

In alternate embodiments of the present invention, the contact image scanner 200 may employ other configurations of the photosensor array 202, conventional N<illumination source 204, and UV illumination source 206. For example, although the conventional illumination source 204 and UV illumination source 206 are shown on opposite sides of the photosensor array 202, the illuminations sources 204, 206 may both be located on a single side or on both sides of the array 202. In a further embodiment, the contact image scanner 200 may employ multiple photosensor arrays 202, such as a conventional photosensor array and a UV photosensor array. Still further, the contact image scanner 200 may comprise additional scanning technologies and features not discussed herein, but known to one skilled in the art, without departing from the scope of the present invention.

As mentioned above, the contact image scanner 200 may be configured to scan one or more types of documents 208, including, but not limited to, checks, money orders, coupons, personal identification, lottery tickets, gambling documents, transportation boarding passes, currency, and other documents used within the gaming, retail, banking, government, and other industries.

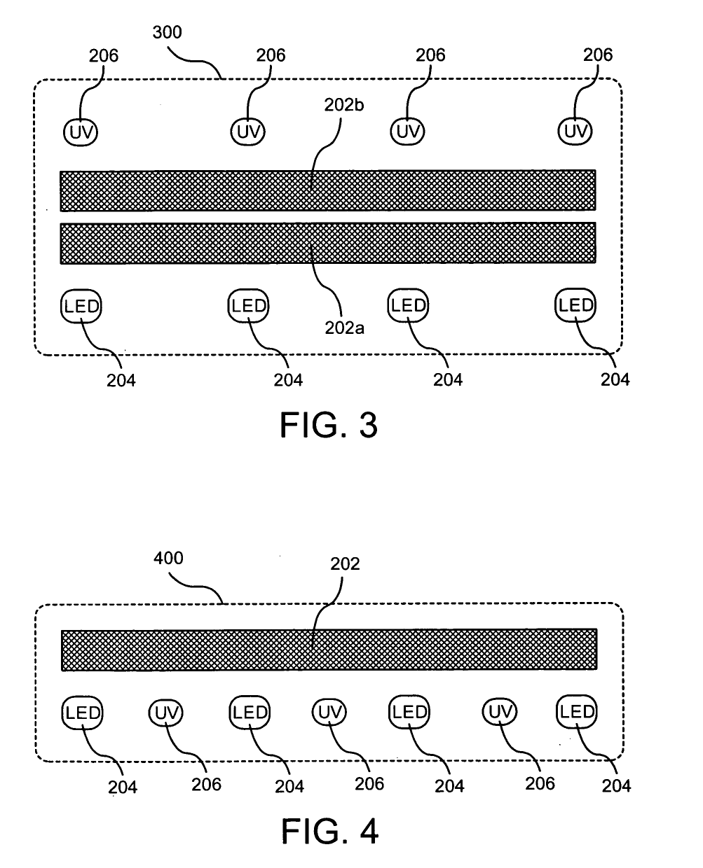

FIG. 3 depicts a plan view of one embodiment of a contact image scanner 300 that is given by way of example of the contact image scanner 200 of FIG. 2. As described with reference to FIG. 2, the contact image scanner 300 of FIG. 3 includes a photosensor array 202, a plurality of conventional illumination sources 204, and a plurality of UV illumination sources 206. As described above, the conventional illumination sources 204 are located on one side of the photosensor array 202, while the UV illumination sources 206 are located on the opposite side of the photosensor array 202.

The contact image scanner 300 of FIG. 3 is distinct, however, in that the photosensor array 202 actually comprises a conventional photosensor array 202a and a UV photosensor array 202b. As the name implies, the conventional photosensor array 202a senses light transmitted by the conventional illumination sources 204 (and reflected by a document 208). Similarly, the UV photosensor array 202b senses light transmitted by the UV illumination sources 206 (and reflected by a document). In this way, the composite photosensor array 202 is capable of sensing both convention and UV illumination. However, in the depicted embodiment, the individual conventional array 202a and UV array 202b may allow for more sensitive detection within each of the illumination spectrums employed.

FIG. 4 is depicts a plan view of another embodiment of a contact image scanner 400 that is a variation of the scanner 200 of FIGS. 2 and 3. In particular, the illustrated contact image scanner 400 of FIG. 4 includes a plurality of UV illumination sources 206 that are interspersed among the plurality of convention illumination sources 204. As shown, both the conventional illumination sources 204 and the UV illumination sources 206 are on the same side of the photosensor array 202 and alternate between conventional sources 204 and UV sources 206.

One advantage of the depicted embodiment over the embodiment shown in FIG. 3 may be the reduced space that is necessary to implement the scanner configuration of FIG. 4. Also, the scanner 4 of FIG. 4 depicts a single photosensor array 202 that is configured to sense both conventional and UV illumination. However, in a further embodiment, the contact image scanner 400 of FIG. 4 also may include more than one photosensor array 202.

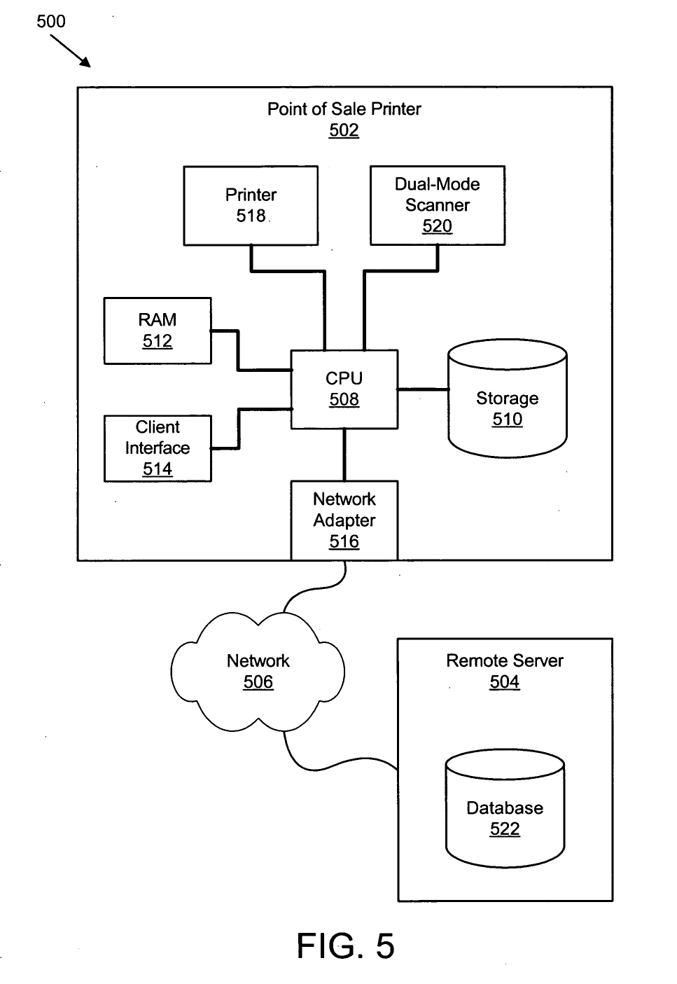

FIG. 5 depicts one embodiment of an authentication system 500 in which various embodiments of the present invention may be employed. The illustrated authentication system 500 includes a POS printer 502 that is connected to a remote server 504 via a network 506. In one embodiment, the POS printer 502 is substantially similar to the POS apparatus 100 of FIG. 1 and employs a contact image scanner that is substantially similar to the scanners 200, 300, 400 of FIG. 2, 3, or 4, respectively. Although the POS printer 502 is referred to as a printer, generally, this nomenclature is employed throughout the art and is not meant to limit the present invention to an apparatus that is or includes a printer. Rather, the illustrated POS printer 502 is used only to exemplify one embodiment of an apparatus in which one or more embodiments of the present invention may be employed.

The network 506 through which the POS printer 502 is connected to the remote server 506 may comprise any known network that is capable of electronic communications as required by the authentication features described below. For example, the communication network 506 may comprise one or more of the following: a local area network (LAN), a wide area network (WAN), another area network, a wireless network, such as radio frequency (RF) or infrared (IR), or another similar network that is known in the art.

The illustrated POS printer 502 includes a central processing unit (CPU) 508, an electronic storage device 510, an electronic memory device 512, such as random access memory (RAM), a client interface 514 and a network adapter 516. These components are configured to operate within their respective capacities as is currently known in the art. Specifically, the CPU 508 processes operational commands within the POS printer 502. The electronic storage device 510 stores electronic data. In one embodiment, the electronic storage device 510 may comprise a hard disk drive, an optical disk, or another type of media currently known in the art.

The electronic memory device 512, in one embodiment, may store control instructions that facilitate execution of the programs and applications that may be implemented on the POS printer 502, including those programs, objects, functions, and so forth that may be necessary for implementation of one or more embodiments of the present invention. The client interface 514 allows data communications between the POS printer 502 and a user via one or more input/output (I/O) devices, such as buttons, displays, a keyboard, an external printer, and so forth. The network adapter 516, as implied above, allows a physical connection to and electronic communication signals over the network 506.

The illustrated POS printer 502 also includes an internal printer 518 and a cat dual-mode scanner 520. As described with reference to the POS apparatus 100 of FIG. 1, the internal printer 518 is configured to print text or other images on a document 208 that is passed through the POS printer 518. However, the printer 518 need not print on each and every document 208 that passes through the POS printer 518, but rather may print on only some or even none of the documents 208.

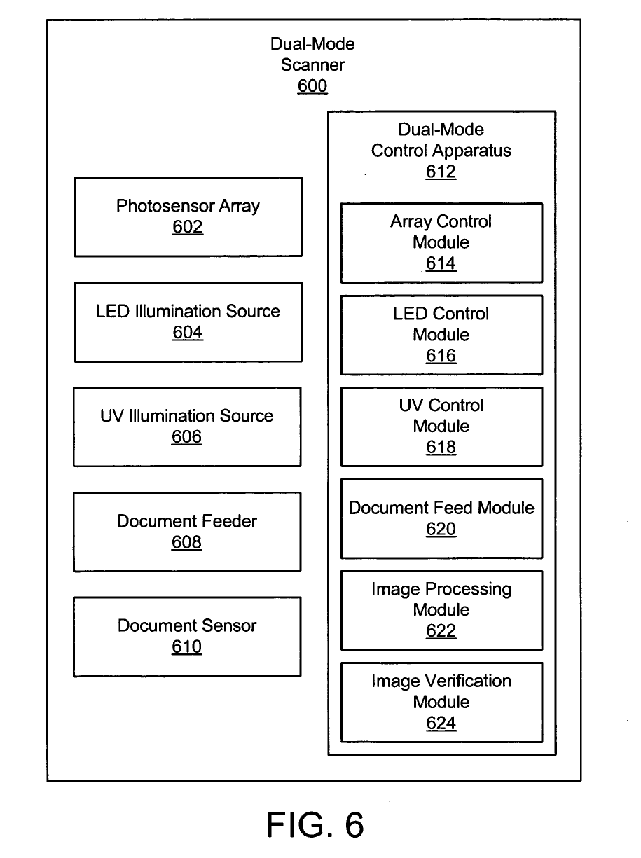

The dual-mode scanner 520 is substantially similar to one or more of the scanners 200, 300, 400 referenced and described above. The term “dual-mode” refers to, in one embodiment, the ability of the scanner to detect both conventional images 212 and UV images 214. In a further embodiment of the POS printer 502, however, the POS printer 502 may employ only a single-mode scanner that is configured to scan for only UV images 214. One example of a dual-mode scanner 520 is described in more detail with reference to FIG. 6.

In particular, FIG. 6 depicts one embodiment of a dual-mode scanner 600 that is substantially similar to the scanner 518 of FIG. 5. The dual-mode scanner 600 is configured to scan a document 208 for both conventional images 212 and UV images. The dual-mode scanner 600 may employ either a single-pass scanning technology or a multiple-pass scanning technology, as described above.

The illustrated dual-mode scanner 600 includes a photosensor array 602, a conventional illumination source 604 (also referred to as an LED illumination source), a UV illumination source 606 a document feeder 608, a document sensor 610, and a dual-mode control apparatus 612. In turn, the illustrated dual-mode control apparatus 612 includes an array control module 614, a conventional (or LED) control module 616, a UV control module 618, a document feed module 620, an image processing module 622, and an image verification module 624.

In one embodiment, the photosensor array 602 is substantially similar to the photosensor array 202 described above. Notably, the photosensor array 602 may comprise a single array 202 capable of sensing both conventional and UV illumination, multiple arrays 202 each capable of sensing both conventional and UV illumination, or multiple arrays 202 individually capable of sensing either conventional or UV illumination. The conventional illumination source 604 is substantially similar to the convention illumination source 204 described with reference to FIG. 2. Similarly, the UV illumination source 606 may be substantially similar to the UV illumination source 206 also described with reference to FIG. 2.

The document feeder 608, mentioned with reference to FIG. 1, controls how a document 208 is fed through the POS printer 502. In conjunction with the document feeder 608, the document sensor 610 may sense when a document is present within the POS printer 518, within the POS apparatus 100 of FIG. 1, or at one of the apertures 102, 104 of the POS apparatus 100. As described above, the document feeder 608 may be configured to pass the document 208 through the POS printer 500, for example, only a single time or multiple times, such as by reversing feed directions.

The array control module 614, in one embodiment, controls the operation of the photosensor array 602. For instance, the photosensor array 602 may sense continually or, alternately, only upon operation of the illumination sources 604, 606. In a further embodiment, the array control module 614 may control a conventional array separately from a UV array, as described above.

The conventional (or LED) control module 616 is configured to control the conventional (or LED) illumination source 604. Similarly, the UV control module 618 is configured to control the UV illumination source 606. The conventional control module 616 and the UV control module 618 may each control when the illumination sources 604, 606 turn on, turn off, and the intensity of the illumination sources 604, 606.

The document feed module 620 controls the document feeder 608 and the document sensor 610. As described above, the document feed module 620 may control the document feeder 608 in order to allow for single-pass scanning and/or multiple-pass scanning. Additionally, the document feed module 620 also may control the location and speed of the document 208 for the printer 518, too.

The image processing module 622, in one embodiment, digitally processes the detected (or sensed) images 212, 214. In certain embodiments, the image processing module 622 may employ one or more processing algorithms, including, but not limited to optical character recognition (OCR), pattern recognition, and so forth. Once the image processing module 622 digitally processes a sensed image 212, 214 the resulting digital representation of the convention image 212 or UV image 214 may be referred to as a processed image.

The image verification module 624 is configured to verify one or more of the processed images. In particular, the image verification module 624 is configured to authenticate a processed UV image by comparing the processed UV image to a benchmark image. For example, a processed UV image containing the alphanumeric characters “AA123XYZ” may be compared against a benchmark image that contains the same characters. The benchmark image, in one embodiment, may be stored on a database 522 on the remote server 504 of the authentication system 500.

In order to know which benchmark image should be used for a given document 208, it may be necessary to employ a document identifier to identify the scanned document 208. For instance, a check that is scanned may have a corresponding document identifier comprising the account and check number. For a given check, the database 522 may include a benchmark image that is unique to that document identifier. By transmitting the document identifier to the remote server 504, for example, the image verification module 624 may determine which benchmark image should be used and further determine if the processed UV image is sufficiently similar to the identified benchmark image.

In some cases, it is foreseeable that a processed UV image may be similar, but not identical, to a given benchmark image due to the quality of the UV image 212 and/or the ability of the image processing module 622 to accurately process the sensed Uv image. Given this potential discrepancy between the processed UV image and the corresponding benchmark image, it may be possible to employ a verification threshold that allows the processed UV image to be similar to the benchmark, without being identical, within the verification threshold. The verification threshold for a benchmark image may be determined by the image processing algorithm(s) employed, the complexity of the original image, the document medium on which the image is printed, the scan quality of the dual-mode scanner 600, and so forth. In certain embodiment, the verification threshold for each processed image may be determined by the image verification module 624 and transmitted to the remote server 504 or otherwise used when comparing the processed UV image to the corresponding benchmark image.

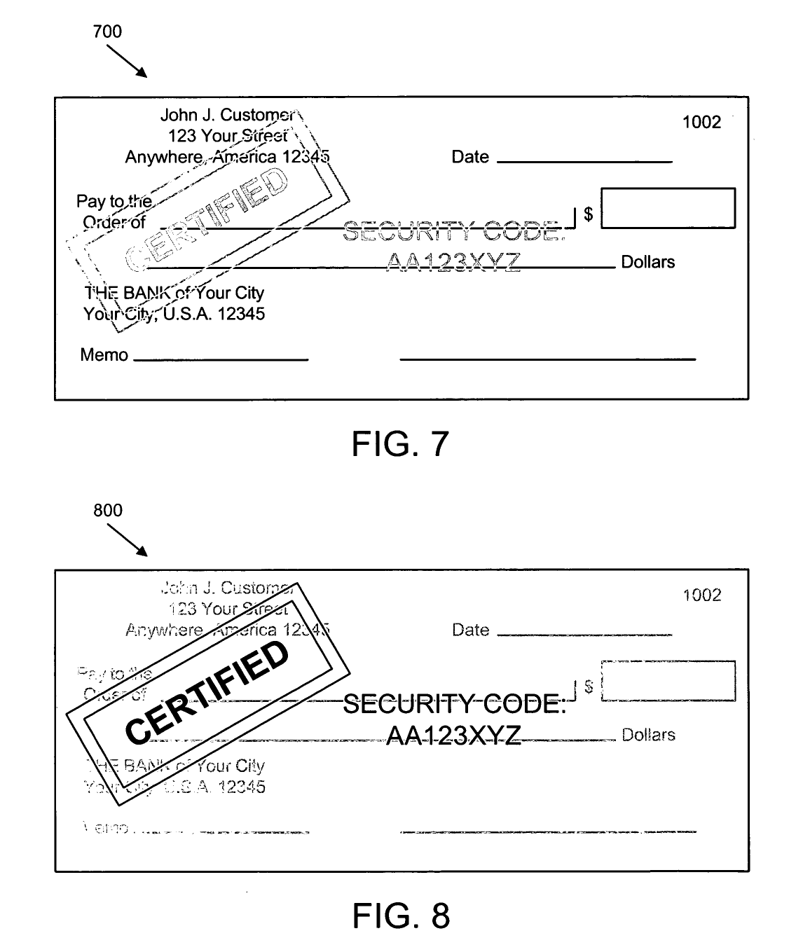

FIG. 7 depicts one embodiment of a document 700 having both a conventional image 212 and a UV image 214 printed thereon. Specifically, the document 700 is representative of a personal check that may be used to purchase goods at a retail store. While the conventional image 212 (shown in black) is visible to the naked eye, the UV image (shown in gray for ease of discussion) may not be readily visible or may be completely invisible to the naked eye. When scanned by a POS printer 500 and processed by the image processing module 622, the processed conventional image may accurately represent the printed conventional image 212.

However, as depicted in FIG. 8, when the document 700 is scanned using a UV illumination source 606 and processed accordingly, the printed UV image 214 becomes apparent in the processed UV image 800. For clarification, then, FIG. 7 depicts the document 700 while FIG. 8 depicts the processed UV image 800, although additional printed images 212, 214 are also shown (in gray) for reference purposes only.

Although the printed UV image 214 was not visible on the original printed document 700, the UV scanning may reveal a verification code or other printed UV image 214 that was originally printed, but invisible, on the document 700. In this way, conventional scanning of the document 700 results in a processed conventional image that is similar to the visible conventional image 212 printed on the document 700. Likewise, UV scanning results in a processed UV image 800 that is similar to the previously invisible printed UV image 214.

The following schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbology employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

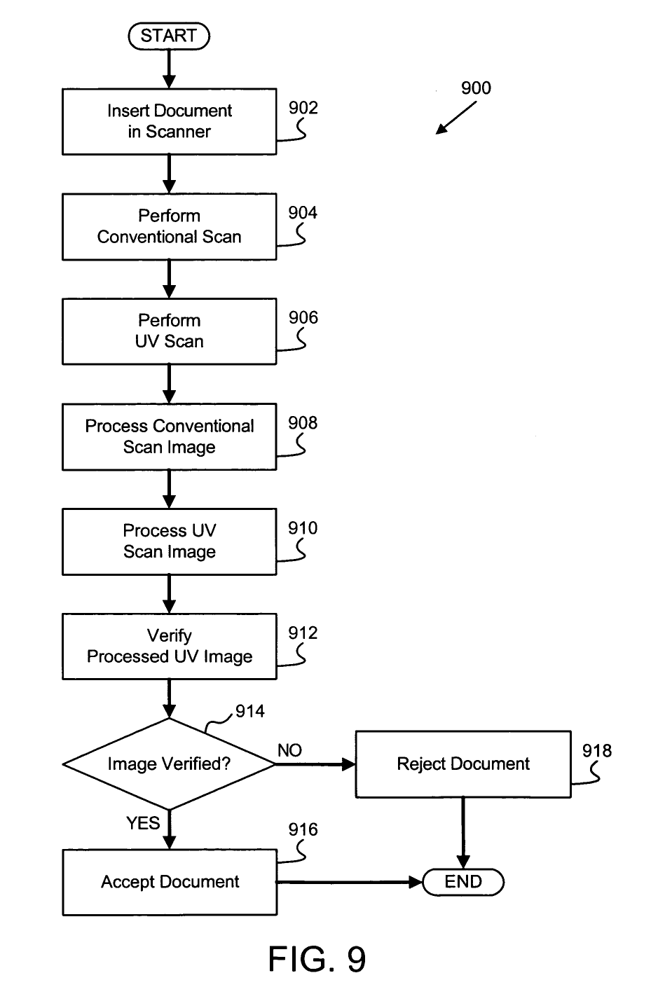

FIG. 9 depicts one embodiment of an authentication method 900 that may be employed to verify and authenticate a document 208 using the UV scanning technology presented in the various embodiments of the present invention. The illustrated authentication method 900 begins when a user inserts 902 a document 208 into the scanner 600.

In a multiple-pass scanner 600, the document feeder 608 may pass the document 208 in a first direction and perform 904 a conventional scan. The document feeder 608 may subsequently pass the document 208 in the reverse direction and perform 906 a UV scan. As used within the description of FIG. 9, “perform” refers to illuminating the corresponding illumination source 604, 606 and sensing the reflected light at the photosensor array 602. Alternately, the scanner 600 may perform 904, 906 the scans concurrently in a single pass or over multiple passes.

The image processing module 622 then processes 908 the sensed convention image and processes 910 the sensed UV image. Once the sensed UV image is digitally processed 910 to create the processed UV image, the image verification module 624 may verify 912 the processed UV image by accessing a corresponding benchmark image from the database 522 on the remote server 504. As described above, the corresponding benchmark image may be identified, in one embodiment, by a document identifier associated with the scanned document 208. Using the benchmark image, the image verification module 624 may determine 914 if the processed UV image is authentic and properly corresponds to the scanned document 208.

If the image verification module determines 914 that the processed UV image is correct according to the benchmark image, the scanner 600 may accept 916 the scanned document 208. As used herein, the scanner 600 may accept 916 the scanned document 208 in a variety of ways, such as by transferring funds, visually indicating acceptance to a user, executing a digital transaction, and so forth, depending on the type of document verified.

However, if the image verification module determines 914 that the processed uV image is not correct according to the benchmark image, the scanner 600 may reject 918 the scanned document 208 by taking contrary actions, i.e. not executing a transaction. After accepting 916 or rejecting 918 the scanned document 208, the depicted authentication method 900 then ends.

Advantageously, certain embodiments of the present invention facilitate enhanced security authentication of a variety of scanned documents. In particular, the present invention, in various embodiments, provides for UV scanning of a document and image verification of the processed UV image, according to a predefined benchmark image that is associated with the scanned document. Additionally, the possibility and likelihood of operator error is greatly reduced due to the automated nature of the UV technology described.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus to authenticate a scanned document, the apparatus comprising:
an ultraviolet (UV) illumination source configured to illuminate a document having a UV image printed thereon;
a photosensor array configured to sense the UV image while illuminated by the UV illumination source;
an image processing module configured to digitally process the sensed UV image; and
an image verification module configured to compare the processed UV image with a corresponding benchmark image.

2. The apparatus of claim 1, further comprising a conventional illumination source configured to illuminate the document having a conventional image printed thereon.

3. The apparatus of claim 2, wherein the photosensor array is further configured to sense the conventional image while illuminated by the conventional illumination source.

4. The apparatus of claim 1, wherein the UV illumination source and photosensor comprise a contact image scanner.

5. The apparatus of claim 1, further comprising a UV control module configured to control the UV illumination source and the photosensor array.

6. The apparatus of claim 1, wherein the UV image is an authentication key.

7. The apparatus of claim 1, wherein the UV image comprises an alphanumeric code.

8. The apparatus of claim 1, wherein the UV image comprises a pictorial image.

9. The apparatus of claim 1, wherein the UV image comprises a pattern code.

10. The apparatus of claim 1, wherein the benchmark image is located on a remote electronic storage device.

11. The apparatus of claim 1, wherein the image processing module is further configured to employ optical character recognition algorithms to process the sensed UV image.

12. The apparatus of claim 1, wherein the image verification module is further configured to accept the document as authentic in response to a determination that the processed image is compatible with the corresponding benchmark image.

13. The apparatus of claim 1, wherein the image verification module is further configured to reject the document as authentic in response to a determination that the processed image is not compatible with the corresponding benchmark image.

14. The apparatus of claim 1, wherein the document is identified by a document identifier and the corresponding benchmark image is identified by the document identifier.

15. A document scanning system to authenticate a scanned document, the system comprising:
a contact image sensor having a UV illumination source and a photosensor array, the UV illumination source configured to illuminate a document having a UV image printed thereon, the photosensor array configured to sense the UV image while illuminated by the UV illumination source;
an image processing module configured to digitally process the sensed UV image; and
an image verification module configured to compare the processed UV image with a corresponding benchmark image.

16. The system of claim 14, further comprising a conventional illumination source configured to illuminate the document having a conventional image printed thereon.

17. The system of claim 15, wherein the photosensor array is further configured to sense the conventional image while illuminated by the conventional illumination source.

18. The system of claim 15, further comprising a conventional photosensor array distinct from the photosensor array configured to sense the UV image, the conventional photosensor array configured to sense the conventional image while illuminated by the conventional illumination source.

19. A point-of-sale system to authenticate a scanned document, the system comprising:
a contact image sensor configured to scan a document and sense a a UV image printed thereon;
point-of-sale printer configured to print a visible image on the document;
a network interface configured to connect to a network and allow an electronic communication signal between the contact image sensor and a remote electronic storage device;
an image processing module configured to digitally process the sensed UV image; and
an image verification module configured to compare the processed UV image with a corresponding benchmark image stored on the remote electronic storage device.

20. The system of claim 19, wherein the contact image sensor is configured to sense the UV image during at least one pass of the document within a multiple-pass document feeder.

21. The system of claim 19, wherein the contact image sensor is configured to sense the UV image during a single pass of the document within a single-pass document feeder, the contact image sensor concurrently sensing a conventional image.

22. A signal bearing medium tangibly embodying a program of machine-readable instructions executable by a digital processing apparatus to perform operations to authenticate a scanned document, the instructions comprising operations to:
digitally scan a document and sense a UV image printed thereon;
digitally process the sensed UV image; and
compare the processed UV image with a corresponding benchmark image.

23. The signal bearing medium of claim 22, wherein the instructions further comprise operations to illuminate the document having a conventional image printed thereon.

24. The signal bearing medium of claim 23, wherein the instructions further comprise operations to sense the conventional image while illuminated by the conventional illumination source.

25. The signal bearing medium of claim 22, wherein the instructions further comprise operations to control the UV illumination source and the photosensor array.

26. The signal bearing medium of claim 22, wherein the benchmark image is located on a remote electronic storage device.

27. The signal bearing medium of claim 22, wherein the instructions further comprise operations to employ optical character recognition algorithms to process the sensed UV image.

28. The signal bearing medium of claim 22, wherein the instructions further comprise operations to accept the document as authentic in response to a determination that the processed image is compatible with the corresponding benchmark image.

29. The signal bearing medium of claim 22, wherein the instructions further comprise operations to reject the document as authentic in response to a determination that the processed image is not compatible with the corresponding benchmark image.

30. The signal bearing medium of claim 22, wherein the instructions further comprise operations to identify the document with a document identifier and identify the corresponding benchmark image with the document identifier.

31. A method for authenticating a scanned document, the method comprising:
employing a UV illumination source and a photosensor array to digitally scan a document and sense a UV image printed thereon;
digitally processing the sensed UV image; and
comparing the processed UV image with a corresponding benchmark image.

32. An apparatus to authenticate a scanned document, the apparatus comprising:
means for digitally scanning a document and sense a UV image printed thereon;
means for digitally processing the sensed UV image; and
means for comparing the processed UV image with a corresponding benchmark image.
